(19) United States
(12) Patent Application Publication
(10) Pub. No.: US 2026/0301481 A1
(43) Pub. Date: Oct. 1, 2026

(54) CHARGING OR FUEL TANK FLAP ASSEMBLY FOR A VEHICLE AS WELL AS LIGHTING MODULE FOR SUCH A CHARGING OR FUEL TANK FLAP ASSEMBLY

(71) Applicant: Illinois Tool Works Inc., Glenview, IL (US)

(72) Inventors: Thomas Rader, Pliezhausen (DE); Roland Och, Rottendorf (DE)

(21) Appl. No.: 19/477,345

(22) PCT Filed: Apr. 25, 2024
(86) PCT No.: PCT/IB2024/000214

§ 371 Date: Oct. 21, 2025

(30) Foreign Application Priority Data
Apr. 26, 2023 (DE) 10 2023 110 780.1

(51) Int. Cl. G07C 5/08; B60K 15/05; B60L 53/16; B60Q 1/24; E05F 15/60

(52) U.S. Cl. CPC G07C 5/0808; B60K 15/05; B60L 53/16; B60Q 1/24; E05F 15/60; G07C 5/0816; E05Y 2400/354; E05Y 2900/534

(57) ABSTRACT

The invention relates to a charging or fuel tank flap assembly (1) for a vehicle. The charging or fuel tank flap assembly (1) has at least one charging or fuel tank flap (2) for inserting into an opening of a vehicle body or into an opening of a vehicle outer skin, a cover (3) which is operatively connected to a mechanism such that the cover (3) can be converted relative to the charging or fuel tank flap (2) between a closed position, which covers at least some parts or regions of the charging or fuel tank flap (2), and an open position, which releases at least parts or regions of the charging or fuel tank flap (2), and a sensor unit (4), in particular for detecting the position and/or the state of the cover (3). In particular, the charging or fuel tank flap assembly (1) also has a controller (9) comprising a microcontroller, which is connected to the sensor unit (4) via a data line, in particular via a data bus, said controller (9) having an interface for connecting to an LIN network.

The present invention relates generally to a new concept with which the functions of a vehicle component, for example the functions of a charging or fueling compartment assembly of a vehicle, can be centrally controlled by a control device in order to minimize the necessary wiring of the functional components of the vehicle component with the vehicle control device.

Specifically, the present invention relates in particular to a charging or fueling compartment assembly for a vehicle having its own control device, via which a plurality of functions and preferably all functions of the charging or fueling compartment assembly can be controlled.

According to one aspect of the present invention, it is implemented in particular in the form of a lighting module for illuminating, in particular optionally or as needed, and in particular highlighting a region of a vehicle component, in particular a region of a charging or fueling compartment or a region of a handle assembly.

In other words, when the term “vehicle component” is used herein, it refers in particular to a charging or fueling compartment assembly for a vehicle.

Alternatively, however, it is also contemplated that the vehicle component is, for example, a handle assembly (inside door handle or outside door handle assembly) of a vehicle.

Vehicles with a hybrid or electric drive have at least one battery or traction battery, which, for example, in the case of PHEV (Plug-In Hybrid Electrical Vehicle) or BEV (Battery Electric Vehicle) vehicles, can be charged via an electrical charging connection that is accessible from the outside of the vehicle body or on the vehicle outer skin, which is usually a charging box, by connecting it to an electric charging station or a conventional domestic power supply, for example.

The charging connection is usually located in a charging compartment in the vehicle body or vehicle outer skin, which is normally covered or closed by a sealing element (also referred to below as a “cover”). A mechanism interacting with the closure element or the cover allows the charging bay to be opened and closed or the closure element (if designed as a charging flap) to be opened and closed relative to the charging bay, thus providing access to the charging connection.

The mechanism can, for example, include push-push kinematics, as already used in conventional fuel caps. Since, in practice, a seal is usually missing between the locking element and the charging tray when using such a push-push mechanism, which would, however, be necessary to protect the electrical charging connection, which has metallic contacts, from the ingress of dirt, dust, and liquids, in particular water, and thus ensure its long-term function, an additional charging connection flap is currently required, which is placed or screwed onto the charging connection to protect it.

By contrast to internal combustion engine vehicles, which are typically filled with fuel at gas stations where the fueling operation occurs either during the day or in an illuminated environment, the charging operation often occurs in the dark in vehicles having a hybrid or electric drive. For example, it is common for a vehicle having a hybrid or electric drive to be re-charged in a dark, non-illuminated, underground parking lot. In this case, it is extremely advantageous if the operator or driver can find the charging plug connector in the charging compartment more easily with the help of suitable lighting.

For this purpose, it is known to provide illumination in the charging compartment.

It can also be provided that illuminants are arranged around the charging connector in the charging compartment in order to identify the charging connector.

For example, DE 10 2011 108 817 A1 describes a charging device for an electric vehicle in which segment-like illuminants are arranged around the charging plug connector in the charging compartment in such a way that they form a closed ring around the charging plug connector. The LEDs serve to illuminate the charging connector and also provide a kind of scale that can be used to visualize the state of charge of an electric vehicle battery.

Accordingly, it can be seen that loading or fueling compartment assemblies of a vehicle in particular must have different functionalities: on the one hand, it is preferable that appropriate lighting is provided, in particular to highlight a region of a loading or fueling compartment of the loading or fueling compartment assembly. This lighting should preferably also visualize a state of charge of a battery of the vehicle to be charged.

On the other hand, it is common or desirable for a position of a cover of the charging or fueling compartment assembly to be detected or monitored. This applies in particular to vehicles that have several charging or fueling compartment assemblies, for example on the port side and the starboard side of the vehicle. For such vehicle types, it shall be ensured that the cover of the charging or fueling compartment assembly not used for charging the vehicle battery is securely closed with the appropriate cover to prevent access to a charging box of that charging or fueling compartment assembly.

However, even for vehicle types that have only a single cargo or fueling compartment assembly, the detection of a position of the cover of the cargo or fueling compartment assembly is desirable to ensure that the cargo or fueling compartment of the vehicle is securely closed when the vehicle is in operation.

The cover, on the other hand, can usually also assume different states, especially in the closed position of the cover. This, for example, is an unlocked state in which the cover can be moved from the closed position to the open position either manually or by an electric motor, and a locked state in which the cover cannot be moved from the closed position to the open position. The cover's state (unlocked/locked) is often controlled by an electric motor. It would also be desirable to be able to record the condition of the cover.

Further functionalities of a charging or fueling compartment assembly exist. As an example, the cover of the charging or fueling compartment assembly can often be moved by electric motor from its closed position to the open position and/or vice versa.

Another example is monitoring the charge state of the vehicle battery.

It should therefore be noted that vehicle components, such as charging or fueling compartment assemblies, have a variety of functionalities. The functions of the charging or fueling compartment assembly are usually controlled by at least one electromotive actuator (often also by several electromotive actuators). In addition, control of the illumination/highlighting of the charging or fueling compartment is desired, as well as optional control of the charging status display.

This example shows that the individual vehicle components must increasingly take on various functions that need to be controlled appropriately. The control of the individual functions of the vehicle component, such as a charging or fueling compartment assembly, is usually carried out depending on the detection results of a sensor system.

For example, in the case of a charging or fueling compartment assembly, a sensor system can be used in particular to detect a position of the cover of the charging or fueling compartment assembly and/or to detect a state of the cover (unlocked state/locked state).

In order to control the individual functionalities or functional components of the vehicle component, it is known that the individual functional components, in particular electromotive actuators, are operatively connected to a corresponding sensor system, wherein the sensor system and the functional components are connected via a data line or control line are connected to the vehicle control device, which is typically embodied as a CAN bus.

However, this approach, which has been implemented thus far, has various disadvantages. In particular, it is often necessary for the individual functional components of the vehicle component to be user-specifically designed in order to ensure appropriate actuation via the vehicle bus system.

In addition, during the integration of the vehicle components, a significant amount of effort is required for the wiring and/or provision of the necessary data and control lines.

Based on this situation, the problem addressed by the present invention is to specify a charging or fueling compartment assembly for a vehicle, which can perform a variety of different functions, wherein the charging or fueling compartment assembly can simultaneously be integrated into the vehicle concept in an easily realized and cost-effective manner.

This problem is solved in particular by the subject-matter of independent claim 1, wherein advantageous further developments of the charging or fueling compartment assembly according to the invention are specified in the dependent claims 1 to 15.

According to a preferred realization of the solution according to the invention, it relates to a lighting module for a vehicle component, in particular for a charging or fueling compartment assembly or for a handle arrangement, as specified in the parallel claims 16 and 19.

Accordingly, the invention relates in particular to a charging or fueling compartment assembly for a vehicle, wherein the charging or fueling compartment assembly comprises at least one charging or fueling compartment for insertion into an opening of a vehicle body or into an opening of a vehicle outer skin. The charging or fueling compartment assembly further comprises a cover associated with the at least one charging or fueling compartment, which is operatively connected to a mechanism in such a way that the cover can be moved relative to the charging or fueling compartment between a closed position covering the charging or fueling compartment at least partially or zonally and an open position releasing the charging or fueling compartment at least partially or zonally.

Finally, the charging or fueling compartment assembly comprises a sensor system in particular for detecting a position and/or a state of the cover associated with the at least one charging or fueling compartment.

According to the invention, it is provided in particular that the charging or fueling compartment assembly further comprises a control device having a microcontroller, which is connected to the sensor system via a data line, in particular via a data bus, and wherein the control device comprises an interface for connecting to a LIN network.

The interface supports the LIN protocol according to the standard ISO 17987 (as of: date of filing) and is preferably configured so as to be used in the slave operation mode. A LIN (Local Interconnect Network) bus is a serial communication system and is based on a single-wire bus. A LIN bus is easy to set up and cost effective to implement.

In the embodiment of the charging or fueling compartment assembly according to the invention, the control device preferably serves as a slave in the LIN bus and serves to control the controllable components of the charging or fueling compartment assembly, for example, electromotive actuators, light sources, etc. appropriately.

The control device has knowledge of a chronological order of the data to be transmitted to the respective controllable components of the charging or fueling compartment assembly.

Preferably, the control device comprises a storage unit in which different mechanical setting positions for electromotive actuators of the charging or fueling compartment assembly are stored. Each setting position is associated with a corresponding driving command, which the control device transmits to the electromotive actuators of the charging or fueling compartment assembly each time one of these positions of the electromotive actuators is to be adjusted.

The sensor system of the charging or fueling compartment assembly comprises at least one sensor or at least one sensor unit and/or at least one switch, in particular a micro-switch.

The sensor system is in particular configured so as to collect data regarding the current circumstances relating to the charging or fueling compartment assembly or the environment of the charging or fueling compartment assembly and to provide it for processing for the control device.

For example, it is contemplated that the sensor system can comprise a sensor unit and/or switch, in particular micro-switch, which detects the position of the cover relative to the charging or fueling compartment.

In particular, the sensor system is configured so as to detect a closed position of the cover associated with the at least one charging or fueling compartment and/or an open position of the cover associated with the at least one charging or fueling compartment. Alternatively, or in particular additionally, for this purpose, the sensor system can be configured so as to detect a state of the cover associated with the at least one charging or fueling compartment.

As used herein, the term “state of the cover” means, in particular, a locked state or an unlocked state of the cover.

It is known to associate technical systems in vehicles with a risk classification metric that identifies the potential hazard of the technical system. The risk classification metric, referred to as the ASIL (Automotive Safety Integrity Level), can be of varying degrees depending on the potential hazard for different technical systems in the vehicle. Four ASIL metrics are distinguished (A, B, C, and D), wherein ASIL A represents only a relatively low potential for hazards and ASIL D represents a high potential for hazards. The ASIL metric is composed of characteristics for the probability of occurrence, based on the frequency distribution of a state variable of a driving situation, the manageability of a hazardous situation in the event of a malfunction in this driving situation, and the severity of the hazardous situation. Each of these metrics is assigned a numerical value, with the ASIL metric being the sum of the numerical values.

So that the charging or fueling compartment assembly according to the invention can be categorized at least in ASIL A and preferably in ASIL B, according to implementations of the charging or fueling compartment assembly according to the invention, it is provided that the sensor system comprises at least one diagnostic-capable switch and in particular at least one diagnostic micro-signal switch.

In this context, it is provided in particular that the at least one diagnostic-capable switch is configured so as to detect at least one of the following states:
a closed position of the cover associated with the at least one charging or fueling compartment;
an open position of the cover associated with the at least one charging or fueling compartment;
a state indicating whether a charging plug is connected to a plug connector of the at least one charging or fueling compartment;
a state indicating whether a charging plug connected to a plug connector of the at least one charging or fueling compartment is locked; and/or
a state of charge.

In design variants of the charging or fueling compartment assembly according to the invention, the charging or fueling compartment assembly comprises a first charging or fueling compartment and at least one further, second charging or fueling compartment.

It can be appreciated that the at least one diagnostic-capable switch is configured so as to detect at least one of the following states:
a closed position of the cover associated with the first charging or fueling compartment;
an open position of the cover associated with the first charging or fueling compartment;
a state indicating whether a charging plug is connected to a plug connector of the first charging or fueling compartment;
a state indicating whether a charging plug connected to a plug connector of the first charging or fueling compartment is locked;
a closed position of the cover associated with the at least one second charging or fueling compartment;
an open position of the cover associated with the at least one second charging or fueling compartment;
a state indicating whether a charging plug is connected to a plug connector of the at least one second charging or fueling compartment; and/or
a state indicating whether a charging plug connected to a plug connector of the at least one second charging or fueling compartment is locked.

For example, it is possible for the sensors to detect which plug connector or which charging or fueling compartment is being used for currently supplying electrical energy to the vehicle or a battery of the vehicle, so that the control device then automatically disconnects the other charging or fueling compartment from the in-vehicle power system. Thus, relatively complex high-volt relay circuits can be omitted.

For example, the need for ASIL A or B-enabled detection of the location of the cover from a charging or fueling compartment will depend on the installation situation, the kinematics associated with the cover, and in particular the high-voltage architecture of the vehicle.

For an ASIL A-capable charging compartment system, it is sufficient for a light module of the charging or fueling compartment assembly or the microcontroller contained therein to process a simple signal, e.g. from a diagnostic-capable micro-switch that detects a closed cover, together with a motor driver for an actuator that can open and close the cover, in particular so as to ensure the closed position of the cover.

This is used when an open cover allows for the assumption of a rather low hazard with a comparatively low risk of injury. For example, a pedestrian or cyclist gets stuck on an open cover, or someone pinches their fingers when the cover closes.

If there is a significant risk of injury due to an open cover, e.g. the contacts are still powered, an ASIL B-enabled system is necessary. In this case, a simple signal is not sufficient, rather a signal must be generated by a redundant system. For example, there are Hall-effect sensors that the two poles of a magnet can detect as separate signals.

According to the invention, this situation should also be able to be implemented in the light module. Similarly, it is also conceivable to integrate ASIL C capability, but then further redundancies would be necessary.

In the charging or fueling compartment assembly according the present invention, the control device is designed in particular as a central control device of the charging or fueling compartment assembly and is configured so as to control, and in particular to coordinate or to control in a coordinated manner, a variety of functions of the charging or fueling compartment assembly and preferably all functions of the charging or fueling compartment assembly, in particular as a function of a position detected by the sensor system and/or in particular as a function of a state of the cover detected by the sensor system.

Accordingly, the present invention is particularly suitable for charging or fueling compartment assemblies that include a variety of functions or functional components.

Here, it can be appreciated that the charging or fueling compartment assembly comprises a plurality of functions or functional components, and wherein the control device, which is designed in particular as a central control device of the charging or fueling compartment assembly, is configured so as to control or coordinate the respective functions or functional components of the charging or fueling compartment assembly via the LIN bus system of the charging or fueling compartment assembly and/or to query the respective functions or functional components of the charging or fueling compartment assembly and preferably to communicate the results of the query via the own bus system of the charging or fueling compartment assembly.

The control device is preferably equipped with an interface, which can be connected to a bus system existing in a vehicle, so that control commands via this bus system are transferable to the control device.

A second control device is arranged in the vehicle and is connected to the bus system arranged in the vehicle, which, in terms of data technology and organization, is superior to the control device of the charging or fueling compartment assembly. At least one command for carrying out a setting for the charging or fueling compartment assembly can be provided by the second control device of the vehicle via the bus system to the interface of the control device of the charging or fueling compartment assembly.

The control device of the charging or fueling compartment assembly receives the at least one command for executing the adjustment and implements the at least one adjustment execution command in at least one drive command for the at least one functional component or controllable component associated with the charging or fueling compartment assembly, respectively, in such a way that the at least one drive command is executable for the at least one functional component of the charging or fueling compartment assembly. The at least one command for executing an adjustment is initiated by the control device of the charging or fueling compartment assembly or by the second control device of the vehicle, in particular as a function of and in consideration of the data of the current conditions in the region of the charging or fueling compartment assembly or in the environment of the charging or fueling compartment assembly as detected by means of sensor system or by means of other sensors.

In particular, according to embodiments of the charging or fueling compartment assembly according to the invention, it is provided that the control device of the charging or fueling compartment assembly, in particular the microcontroller of the control device, is configured as a bridge and is designed so as to connect the dedicated bus system of the charging or fueling compartment assembly to a vehicle bus system. For example, the vehicle bus system is a CAN bus or a MOST bus.

In this context, it is provided in a contemplated realization of the charging or fueling compartment assembly that, in order to transition the cover from the closed position to the open position, and vice versa, the charging or fueling compartment assembly further comprises push-push kinematics cooperating with the cover and an actuating apparatus having an electromotive actuator.

This push-push kinematics is in particular a push-push kinematics as disclosed in publication DE 10 2018 123 949A1 or in the publication DE 20 2021 106 07 1 U1.

In this context, it is particularly suitable that the electromotive actuator of the actuating apparatus is connected and connectable to the control device of the charging or fueling compartment assembly via a data or control line, via which the electromotive actuator can be controlled by the control device, namely in particular as a function of a position detected by means of the sensor system and/or in particular as a function of a state of the cover detected by means of the sensors.

Alternatively, or in addition to the push-push kinematics cooperating with the cover, it is contemplated that, in order to transition the cover from the closed position to the open position, and vice versa, the charging or fueling compartment assembly further comprises an electromotive actuator cooperating with mechanics.

It can be appreciated that the electromotive actuator of the mechanism is connected and can be connected to the control device of the charging or fueling compartment assembly via a data or control line, via which the electromotive actuator can be controlled by the control device, in particular as a function of a position detected by means of the sensor system and/or in particular as a function of a state of the cover detected by means of the sensor system.

Alternatively or additionally, according to design variants of the charging or fueling compartment assembly according to the invention, it is also provided that the charging or fueling compartment assembly further comprises a lighting module for illuminating, in particular selectively or as needed, and in particular highlighting, a region of the charging or fueling compartment and/or for visualizing, in particular selectively or as needed, a state of the charging or fueling compartment assembly.

For example, the lighting module can be a lighting module as disclosed in the publication DE 10 2021 132 947A 1 or in the publication DE 10 2019 127246A1 .

In this context, it is appreciated that the light source is connected and can be connected to the control device of the charging or fueling compartment assembly via a data or control line, via which the light source can be controlled by the control device, in particular as a function of a position detected by means of the sensor system and/or in particular as a function of a state of the cover detected by means of the sensor system.

A particularly compact design of the lastly mentioned design variant of the charging or fueling compartment assembly provides that the control device with the microcontroller is a component of the lighting module.

In particular, the lighting module comprises an illuminant carrier, in particular in the form of a printed circuit board, on which the at least one illuminant, in particular designed as an LED, is arranged. Additionally, the lighting module comprises a housing in which the illuminant carrier with the at least one illuminant is at least partially or regionally received. The housing comprises at least one light outlet region, via which light emitted by the at least one illuminant can be decoupled from the housing.

Preferably, the microcontroller of the control device is also arranged on the illuminant carrier.

According to implementations of the charging or fueling compartment assembly according to the invention, the sensor system is configured so as to detect a position, in particular a closed position, an open position, and/or at least one intermediate position of the cover.

Alternatively or additionally, the sensor system is configured so as to detect a state of the cover, in particular a locked state and/or an unlocked state of the cover. Also alternatively or additionally for this purpose, the sensor system is configured so as to detect a state in which a charging plug is inserted into a charging box of the charging or fueling compartment assembly and, if necessary, locked therein. Alternatively or additionally, it is contemplated that the sensor system is configured so as to detect a state of charge.

In particular, the sensor system comprises at least one switch, in particular a micro-switch.

The sensor system is preferably also a component of the lighting module.

The invention further relates to a lighting module for illuminating, in particular selectively or as needed, and in particular highlighting a region of a vehicle component, in particular a region of a charging or fueling compartment, preferably a charging or fueling compartment of the type according to the invention as described above, or a region of a handle assembly of a vehicle.

The illumination module comprises an illuminant carrier, in particular in the form of a printed circuit board, having at least one illuminant, preferably in the form of an LED. Additionally, the lighting module comprises a housing in which the illuminant carrier with the at least one illuminant is at least partially or regionally received. The housing comprises a light outlet region, via which light emitted by the at least one illuminant can be decoupled from the housing. Optionally, the lighting module comprises a light diffuser that is or can be optically coupled to the light outlet region of the housing.

The lighting module according to the invention is in particular characterized in that it further comprises a control device having a microcontroller. The control device is in particular designed as a central control device of the vehicle component and is configured so as to control a plurality of functions of the vehicle component.

According to preferred implementations of lighting module according to the invention, the control device comprises a microcontroller, which is designed as a bridge and is configured so as to connect a bus system of the vehicle component to a vehicle bus system, in particular to a CAN bus of the vehicle bus system.

It is appreciated in particular that the control device of the lighting module is connected to a sensor system via a data line, in particular via a data bus, in particular for detecting a position and/or a state of a cover of the vehicle component designed as a charging or fueling compartment assembly, and wherein the control device is configured so as to control the plurality of functions of the vehicle component, in particular as a function of a position detected with the aid of the sensor system and/or in particular as a function of a state of the cover detected with the aid of the sensor system.

According to a further aspect of the invention, the lighting module comprises at least one interface (e.g. in the form of a tourniquet clamping device applied to a printed circuit board or a plug device, e.g. a bushing) via which a data line or signal line and/or control line (e.g. as a signal line and/or power supply line) is or can be connected to the lighting module, in particular to the microcontroller of the control device and/or a control device of the vehicle, in order to actuate an actuatable component of the charging or fueling compartment assembly that is or can be connected to the charging or fueling compartment assembly, preferably separately from the lighting module, in particular an electromotive actuator and/or a light source of the charging or fueling compartment assembly, with the aid of the microcontroller of the control device and/or a control device of the vehicle.

Alternatively or additionally, it is provided that the lighting module comprises at least one interface, via which a data line or signal line of a sensor system is or can be connected to the microcontroller of the control device and/or a control device of the vehicle.

Exemplary embodiments of the solution according to the invention are described in further detail below with reference to the accompanying drawings.

The following are shown:

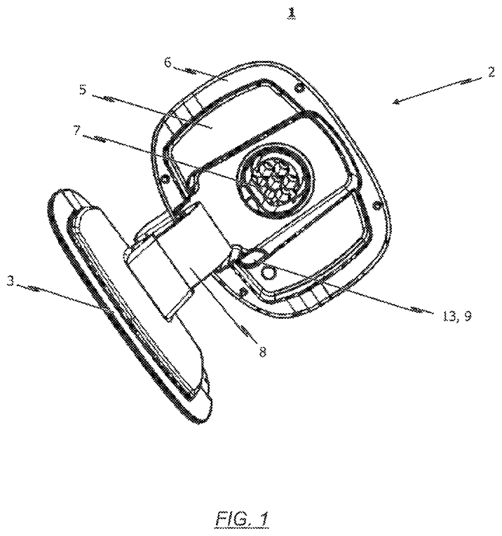

FIG. 1 schematically and in an isometric view, an exemplary embodiment of the vehicle component configured as a charging compartment) in a top plan view, wherein an exemplary embodiment of the lighting module according to the invention is integrated in the charging compartment of the charging compartment assembly; and

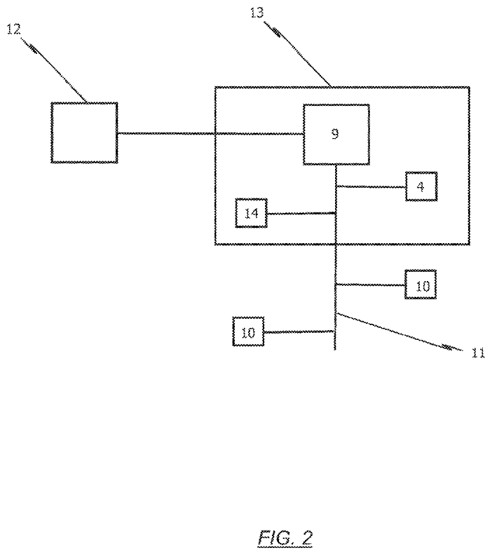

FIG. 2 schematically, the topology of an embodiment of the charging compartment assembly according to the invention with an integrated lighting module and a push-push kinematics cooperating with the cover of the charging compartment assembly and an associated actuating apparatus with an electromotive actuator.

The charging compartment assembly 1 shown in FIG. 1 comprises a charging compartment 2 for insertion into an opening of a vehicle body or into an opening of a vehicle outer skin. The charging 2 is preferably made of plastic and is formed as a whole in a compartment-like shape.

The charging 2 comprises an outer edge 6, which is specified by a compartment body, by means of which the charging compartment 2 can be inserted into a body opening of a vehicle, for example clipped into place. Corresponding snaps (clips) can thus preferably be integrally formed on the compartment body in order to secure the charging compartment 2 to the body opening, in particular a body deep-draw.

A sealing region is preferably provided on the outer edge 6 of the compartment body, which can comprise a circumferential sealing lip formed on the outer edge 6. Instead of such a sealing lip, however, it is also contemplated to design a plurality of sealing blades on the outer edge 6, which are respectively separated from one another at regular circumferential distances by a slot.

In the inner compartment region of the charging compartment 2, a passage opening is formed in which a charging connector 7 is inserted for charging a battery of the vehicle or a tank opening or tank filling tube for fueling a fuel tank.

A cover 3 configured as a closure flap is hinged to the outer compartment body, via which the charging compartment 2 can be optionally closed or released. The cover 3 is in particular a charging or fueling flap arranged with a hinge arm 8 on the outer compartment body, such that the charging or fueling flap 3 is movable, in particular hinged or foldable, relative to the charging compartment 2.

On the side of the charging compartment 2 opposite the hinge arm 8, an opening and closing mechanism can be arranged, which can have a push-push kinematics acting in the direction of the longitudinal axis of the charging compartment 2, i.e. the direction of actuation of the push-push kinematics occurs the direction of the longitudinal axis. By a force exerted on the opening and closing mechanism in the direction of the longitudinal axis, the mechanism can be unlocked and the cover 3/charging flap can be opened or unfolded, or the folded charging flap 3 can be locked.

In the charging compartment 2 shown in FIG. 1, a lighting device is provided, which is formed by an lighting module 13. In the top plan view of the (opened) charging compartment 2 selected in FIG. 1, when looking at the lighting module 13, only a region of a light diffuser of the lighting module 13 is discernible.

The lighting module 13 serves in particular for optional or as-needed illumination and in particular highlighting of a region of the charging compartment 2 and simultaneously for in particular optional or as-needed output of optical signals for the operator or user of the vehicle.

The lighting module 13 comprises substantially an illuminant carrier, for example in the form of a printed circuit board. At least one illuminant is preferably arranged in the form of an LED on the illuminant carrier. Furthermore, a switching device, in particular in the form of a micro-switch, can be arranged on the illuminant carrier.

The lighting module 13 additionally comprises a control device 9 with a microcontroller, which is connected via a data line, in particular via a data bus, to a sensor system 4 of the charging or fueling compartment assembly 1.

In FIG. 2, the topology of an embodiment of the charging compartment assembly according to the invention is shown schematically, with an integrated lighting module.

As indicated, the lighting module 13 comprises a control device 9 with a microcontroller. The control device 9 is embodied as a central control device and is configured so as to control a variety of functions of the charging or fueling compartment assembly 1. The microcontroller of the control device 9 is embodied as a bridge and is configured so as to connect the LIN bus system of the charging or fueling compartment assembly 1 to a vehicle bus system 12, in particular to a CAN bus.

The lighting module 13 further includes a sensor system 4, for example a micro-switch. Via the LIN bus system of the charging or fueling compartment assembly 1, the microcontroller of the control device 9 communicates with other functional components of the charging or fueling compartment assembly 1. These include electromotive actuators 10, further sensors 4, and corresponding light sources 14 of the lighting module 13.

The invention is not limited to the design variants shown in the drawings, but results when all of the features disclosed herein are considered together.

### LIST OF REFERENCE NUMERALS

1 Charging or fueling compartment assembly
2 Charging or fueling compartment
3 Cover
4 Sensor system
5 Compartment body
6 Outer edge of the compartment body
7 Charging connector
8 Hinge arm
9 Control device
10 Electromotive actuator
11 LIN bus
12 Vehicle bus system
13 Lighting module
14 Illuminant/light source

1. A charging or fueling compartment assembly (1) for vehicles, wherein the charging or fueling compartment assembly (1) comprises the following:
at least one charging or fueling compartment (2) for insertion into an opening of a vehicle body or into an opening of a vehicle outer skin;
a cover (3) that is associated with the at least one charging or fueling compartment (2) and is operatively connected to a mechanism in such a way that the cover (3) is transferable relative to a correspondingly associated charging or fueling compartment (2) between a closed position that covers the charging or fueling compartment (2) at least partially or regionally and an open position that releases the charging or fueling compartment (2) at least partially or regionally; and
a sensor system (4) configured to detect a position and/or a state of the cover (3),
wherein the charging or fueling compartment assembly (1) further comprises a control device (9) having a microcontroller, which is connected to the sensor system (4) via a data line via a data bus, and wherein the control device (9) comprises an interface for connecting to a LIN network.

2. The charging or fueling compartment assembly (1) according to claim 1,
wherein the interface supports the LIN protocol and is configured so as to be used in a slave operation mode.

3. The charging or fueling compartment assembly (1) according to claim 1,
wherein the control device (9) is configured as a central control device (9) of the charging or fueling compartment assembly (1) and is configured so as to control a variety of functions or functional components of the charging or fueling compartment assembly (1) and all functions or functional components of the charging or fueling compartment assembly (1), as a function of a position detected by the sensor system (4) and/or as a function of a state of the cover (3) associated with the at least one charging or fueling compartment (2) detected by the sensor system (4).

4. The charging or fueling compartment assembly (1) according to claim 1,
wherein the charging or fueling compartment assembly (1) comprises a plurality of functions or functional components, and wherein the control device (9), which is configured as a central control device (9) of the charging or fueling compartment assembly (1), is configured so as to control the respective functions or functional components of the charging or fueling compartment assembly (1) via an own bus system of the charging or fueling compartment assembly (1) and/or to query the respective functions or functional components of the charging or fueling compartment assembly (1) and to communicate results of the query via the own bus system of the charging or fueling compartment assembly (1).

5. The charging or fueling compartment assembly (1) according to claim 1,
wherein the sensor system (4) comprises at least one diagnostic-capable switch.

6. The charging or fueling compartment assembly (1) according to claim 5,
wherein the at least one diagnostic-capable switch is configured so as to detect at least one of the following states:
a closed position of the cover (3) associated with the at least one charging or fueling compartment (2);
an open position of the cover (3) associated with the at least one charging or fueling compartment (2);
a state indicating whether a charging plug is connected to a plug connector of the at least one charging or fueling compartment (2);
a state indicating whether a charging plug (2) connected to a plug connector of the at least one charging or fueling compartment is locked; and/or
a state of charge.

7. The charging or fueling compartment assembly (1) according to claim 5,
wherein the charging or fueling compartment assembly (1) comprises a first charging or fueling compartment (2) and at least one further, second charging or fueling compartment (2), and wherein the at least one diagnostic-capable switch is configured so as to detect at least one of:
a closed position of the cover (3) associated with the first charging or fueling compartment (2);
an open position of the cover (3) associated with the first charging or fueling compartment (2);
a state indicating whether a charging plug is connected to a plug connector of the first charging or fueling compartment (2);
a state indicating whether a charging plug (2) connected to a plug connector of the first charging or fueling compartment is locked;
a closed position of the cover (3) associated with the at least one second charging or fueling compartment (2);
an open position of the cover (3) associated with the at least one second charging or fueling compartment (2);
a state indicating whether a charging plug is connected to a plug connector of the at least one second charging or fueling compartment (2); and/or
a state indicating whether a charging plug (2) connected to a plug connector of the at least one second charging or fueling compartment (2) is locked.

8. The charging or fueling compartment assembly (1) according to claim 1,
wherein the interface of the control device (9) is designed as a bridge and is configured so as to connect the charging or fueling compartment assembly (1), to a vehicle bus system (12).

9. The charging or fueling compartment assembly (1) according to claim 1,
wherein, in order to transition the cover (3) associated with the at least one charging or fueling compartment (2) from the closed position to the open position and vice versa, the charging or fueling compartment assembly (1) further comprises a push-push kinematics cooperating with the cover (3) associated with the at least one charging or fueling compartment (2) and an actuating apparatus having an electromotive actuator (10), wherein the electromotive actuator (10) of the actuating apparatus is or can be connected to the control device (9) of the charging or fueling compartment assembly (1) via a data or control line, via which the electromotive actuator (10) can be actuated by the control device (9) as a function of a position detected with aid of the sensor system (4) and/or as a function of a state of the cover (3) associated with the at least one charging or fueling compartment (2) detected with the aid of the sensor system (4).

10. The charging or fueling compartment assembly (1) according to claim 1,
wherein, in order to transition the cover (3) associated with the at least one charging or fueling compartment (2) from the closed position to the open position and/or vice versa, the charging or fueling compartment assembly (1) further comprises an electromotive actuator (10) cooperating with the mechanics, wherein the electromotive actuator (10) of the mechanics is or can be connected to the control device (9) of the charging or fueling compartment assembly (1) via a data or control line, via which the electromotive actuator (10) can be actuated by the control device (9), as a function of a position detected with aid of the sensor system (4) and/or as a function of a state of the cover (3) associated with the at least one charging or fueling compartment (2) detected with the aid of the sensor system (4).

11. The charging or fueling compartment assembly (1) according to claim 1,
wherein the charging or fueling compartment assembly (1) further comprises a lighting module (13) for illuminating a region of the charging or fueling compartment (2) and/or visualization of a state of the charging or fueling compartment assembly (1), wherein the lighting module (13) comprises at least one light source, in the form of an LED, wherein the light source is or can be connected to the control device (9) of the charging or fueling compartment assembly (1) via a data or control line, via which the light source can be actuated by the control device (9), as a function of a position detected with aid of the sensor system (4) and/or as a function of a state of the cover (3) associated with the at least one charging or fueling compartment (2) detected with the aid of the sensor system (4).

12. The charging or fueling compartment assembly (1) according to claim 11,
wherein the control device (9) with the microcontroller is a component of the lighting module (13).

13. The charging or fueling compartment assembly (1) according to claim 11,
wherein the lighting module (13) comprises the following:
an illuminant carrier, in the form of a printed circuit board, on which the at least one illuminant, designed as an LED, is arranged; and
a housing in which the illuminant carrier having the at least one illuminant is received at least partially or regionally, wherein the housing comprises at least one light outlet region, via which light emitted by the at least one illuminant can be decoupled from the housing,
wherein the microcontroller of the control device (9) is also arranged on the illuminant carrier.

14. The charging or fueling compartment assembly (1) according to claim 13,
wherein the lighting module comprises at least one interface, via which a data or control line is or can be connected to the microcontroller of the control device (9), in order to actuate an actuatable component of the charging or fueling compartment assembly (1) with aid of the microcontroller of the control device (9).

15. The charging or fueling compartment assembly (1) according to claim 11,
wherein the lighting module comprises at least one interface, via which a data line of a sensor system (4) is or can be connected to the microcontroller of the control device (9).

16. The charging or fueling compartment assembly (1) according to claim 11 wherein the sensor system (4) of the charging or fueling compartment assembly (1) is a component of the lighting module (13).

17. A lighting module (13) for illuminating according to claim 1, or a region of a handle assembly of a vehicle, wherein the lighting module (13) comprises the following:
an illuminant carrier, in the form of a printed circuit board, having at least one illuminant, in the form of an LED;
a housing in which the illuminant carrier having the at least one illuminant is received at least partially or regionally, wherein the housing comprises a light outlet region, via which light emitted by the at least one illuminant can be decoupled from the housing; and,
a light diffuser that is optically coupled or couplable to the light outlet region of the housing,
wherein the lighting module (13) further comprises a control device (9) with a microcontroller, wherein the control device (9) is designed as a central control device (9) of the vehicle component and is configured so as to control a plurality of functions of the vehicle component.

18. The lighting module (13) according to claim 17,
wherein the control device (9) comprises a microcontroller, which is designed as a bridge and is configured so as to connect the vehicle component to a vehicle bus system (12).

19. The lighting module (13) according to claim 17,
wherein the control device (9) of the lighting module (13) is connected to a sensor system (4) via a data line for detecting a position and/or a state of a cover (3) of the vehicle component designed as a charging or fueling compartment assembly (1), and wherein the control device (9) is configured so as to control the plurality of functions of the vehicle component, as a function of a position detected with aid of the sensor system (4) and/or as a function of a state of the cover (3) associated with the at least one charging or fueling compartment (2) detected with the aid of the sensor system (4).

20. The lighting module (13) according to claim 17, wherein
the lighting module (13) comprises at least one interface, via which a data or control line is or can be connected to the lighting module (13), to the microcontroller of the control device (9) and/or a control device of the vehicle, in order to actuate an actuatable component of the charging or fueling compartment assembly (1) that is or can be connected to the charging or fueling compartment assembly (1), separately from the lighting module (13), an electromotive actuator (10) and/or a light source of the charging or fueling compartment assembly (1), with the aid of the microcontroller of the control device (9) and/or a control device of the vehicle; and/or
the lighting module comprises at least one interface, via which a data line of a sensor system (4) is or can be connected to the microcontroller of the control device (9) and/or a control device of the vehicle.
